(19) United States
(12) Patent Application Publication
(10) Pub. No.: US 2004/0090297 A1
(43) Pub. Date: May 13, 2004

(54) Arrangement and method for installing a subsea transformer

(76) Inventors: Gunnar Hafskjold, Drammen (NO); Nils Arne Soelvik, Houston, TX (US)

Correspondence Address: SWIDLER BERLIN SHEREFF FRIEDMAN, LLP, 3000 K STREET, NW, BOX IP, WASHINGTON, DC, 20007, US

(21) Appl. No.: 10/333,119

(22) PCT Filed: Jul. 2, 2001
(86) PCT No.: PCT/IB01/01185

(30) Foreign Application Priority Data
Jul. 24, 2000 (NO) 20003793

(51) Int. Cl. H01F 27/02

(52) U.S. Cl. 336/90

(57) ABSTRACT

The present invention relates to offshore installations, and in particular to an arrangement and a method for use in installation procedures for subsea transformers. In a preferred embodiment of the invention, a central, hole or tube is included in the encapsulation enclosing the transformer which is to be installed. Three core elements of the transformer are arranged symmetrically around the hole or tube forming a triangle or a delta. In the installation process, the transformer is lowered towards a foundation placed on the sea floor wherein a guide pin is mounted. When the transformer has found its way to the foundation, the guide pin will enter the tube, and the transformer will slide down onto the guide line. The tube is terminated by a funnel shaped opening, thus making it easier not to miss the guide pin by the tube opening. The transformer is horizontally oriented by means of orientation keys localized within the tube.

### FIELD OF THE INVENTION

The present invention relates to offshore installations, and in particular to an arrangement and a method for use in installation procedures for subsea transformers.

### BACKGROUND OF THE INVENTION

Today's offshore industry requires a great deal of subsea completions. Especially, the subsea power distribution systems to and between e.g. oil platforms or other offshore power consumers, include a lot of relatively large and heavy components, such as transformers.

The installation process of these components may be both complicated and demanding because of the strong and unpredictable environment the installers encounter. Additionally, the installers have less control over the components because the installation often has to be done remotely, e.g. from a boat. Thus, during the process, there is a considerable risk of damaging the components, and if the installation fails, there are often limited possibilities for correction.

Installation of transformers used in subsea power distribution systems is an example of such a risky installation process. A common technique when installing subsea transformers is to slowly lower the transformer from e.g. a boat, towards a foundation localized on some desired place at the bottom of the sea. Conventionally, transformers are rectangular shaped, and proper placement is ensured by means of two or four guide pins positioned at the edges of the foundation. The guide pins are adapted to fit into some funnels positioned at the transformer's edges such that when the funnels enter all the guide pins, the transformer is meant to be secured a correct position and orientation.

The main drawback of the installation process mentioned above is that large objects, in particular rectangular ones, are widely exposed to underwater currents when being lowered. Experience has shown that they tend to twist around during deployment, especially in deeps where guide wires are not used. This fact makes it difficult to enter the guide pins with the funnels placed at the edges of the transformers, all at the same time.

Moreover, even if the installation apparently has succeeded, the orientation of the transformer may differ 90 or 180 degrees from the correct orientation, if the guide pins have been entered in wrong funnels.

A further drawback is that the transformer risks to jam/wedge between the guide pins, if the installation fails. This may cause damage, or even loss, of the transformer which is to be installed.

Moreover, the transformer may be overturned by the guide pins when sighting the transformer, and this may also cause damage or loss.

### SUMMARY OF THE INVENTION

The object of the present invention is to provide a device and a method, which eliminates the drawbacks described above.

More specifically, the main object of the present invention is to develop a device that may be integrated with subsea components to secure and simplify the installation process.

The above object is achieved by means of a device characterized in the features defined by the claims enclosed.

In short, in a preferred embodiment of the invention, the object is achieved by introducing a central, (through-going or not) funnel (from now on referred to as a receiving channel) in the encapsulation enclosing the transformer which is to be installed. The core elements of the transformer are arranged symmetrically around the receiving device forming a triangle or a delta. In the installation process, a single guide pin mounted in the foundation placed on the sea floor will enter the tube, and the encapsulation will slide down on the guide line. The tube is terminated by a funnel shaped opening, thus making it easier enter the guide pin.

### BRIEF DESCRIPTION OF THE DRAWINGS

In order to make the invention more readily understandable, exemplary embodiments of the present invention will in the following be described with reference to the accompanying drawings.

FIG. 1 shows a 3-D view of a subsea transformer comprising a receiving channel according to a first preferred embodiment of the present invention,

FIG. 2 shows a sectional elevation of the subsea transformer of FIG. 1,

FIG. 3 shows a cross sectional view of the subsea transformer of FIG. 1,

FIG. 4 shows a sectional elevation of a guide pin (4) according to a first embodiment of the present invention, and

FIG. 5 shows an indication of how a second embodiment of the present invention may look like.

### DETAILED DESCRIPTION

With reference to the abovementioned figures, there will in the following be described three exemplary embodiments of the present invention.

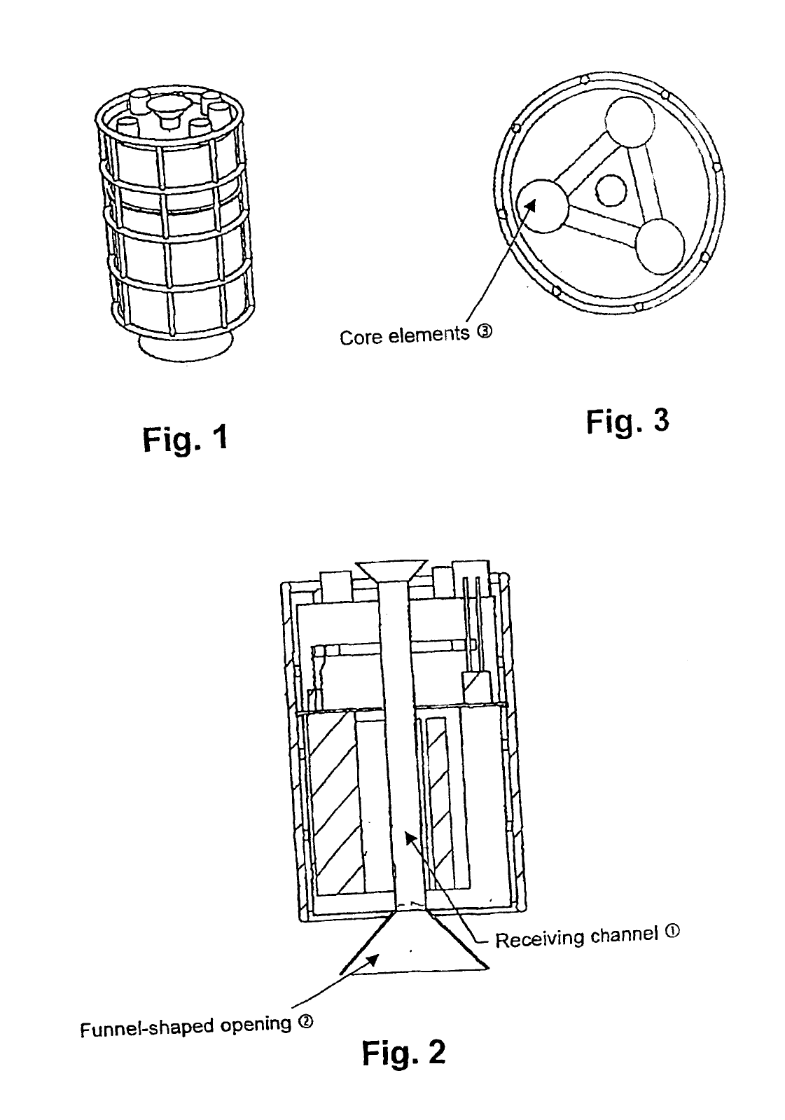

FIG. 1 shows a cylindrical subsea transformer including the receiving channel of the present invention. In this embodiment, the receiving channel (1) runs through the transformer from the top, all the way to the bottom. The cannel does not necessarily have to be through-going. However, it has to be localized in the centre of the cylinder forming the transformer body.

This is illustrated even better in FIG. 2, which shows a sectional elevation of the transformer. The receiving channel (1) is placed at the exact center to make it possible to use only one guide pin (4) in the installation process. Moreover, the centering makes the transformer more stable and easier to handle during installation.

It is also shown that the receiving channel (1) is terminated at the bottom by a funnel-shaped opening (2). This is done for broadening the receiving channel's opening, when sighting it on the guide pin (4) positioned on the foundation. When the top of the guide pin (4) finds its way somewhere within the funnel-shaped opening (2), the funnel-shaped opening (2) will then center the receiving channel (1) with respect to the guide pin (4), which enables the transformer body to be lowered correctly over the guide pin (4).

In addition, the lower part of the receiving channel (1) includes orientation keys. These orientation keys should be positioned in a way so that it will orientate the transformer body to a desired, predetermined horizontal orientation relative to the foundation.

FIG. 3 is a cross-sectional view of the subsea transformer, and illustrates how the core elements (3) are arranged around the central receiving channel (1). In this embodiment, the transformer core consists of three elements. The elements are localized symmetrically around the receiving channel (1), forming a triangle or delta. This implies that adjacent elements are equally spaced, all having the same distance to the central receiving channel (1). This allows the transformer body to be cylindrical or, alternatively, oval or multi-edged.

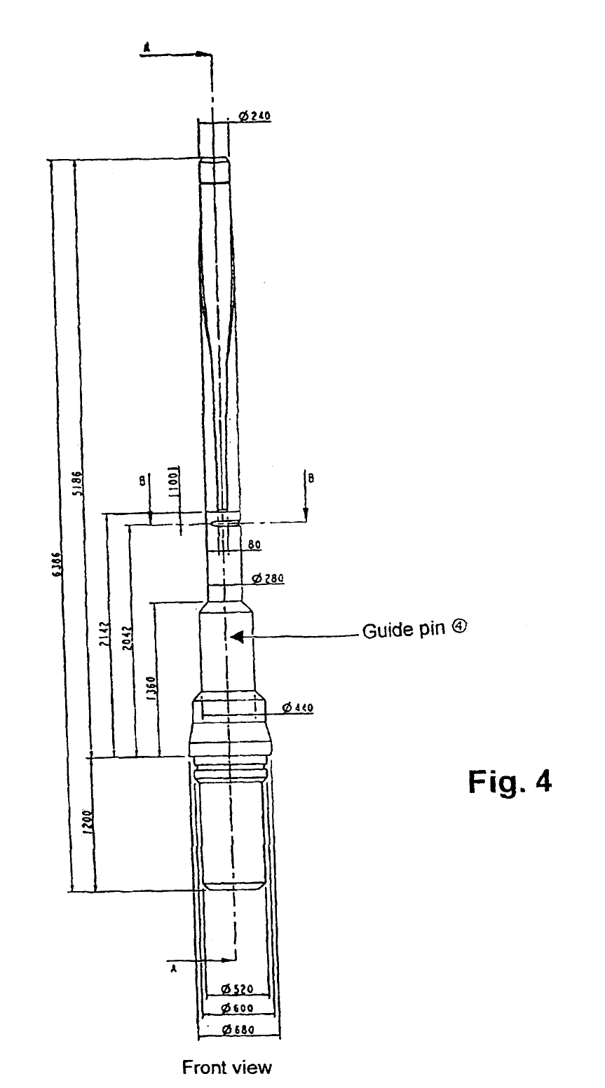

FIG. 4 shows a sectional elevation view of a guide pin (4) mounted on a foundation. The guide pin (4) has approximately the same length as the central receiving channel (1) of the transformer. Moreover, the diameter of the guide pin (4) must not exceed the inner diameter of the central receiving channel (1), but should be dimensioned to smoothly fit into the receiving channel (1). Thus, wavering, when the transformer is lowered over the guide pin (4), is prevented.

The process for installing the transformer described above starts by lowering the transformer body towards the guide pin (4), until it is placed just above the guide pin (4) and the funnel-shaped opening (2) encapsulates the top of it. The transformer is then further lowered down, so that the funnel-shaped opening (2) “lead” the receiving channel opening towards the top of the guide pin (4). When reaching it, the receiving channel (1) will be lowered over the guide pin (4), and the transformer body will smoothly slide down towards the foundation. Finally, the transformer body is oriented horizontally until the orientation keys have positioned the receiving channel (1) to the guide pin (4), leaving the transformer body in a predetermined, desired horizontal orientation relative to the foundation.

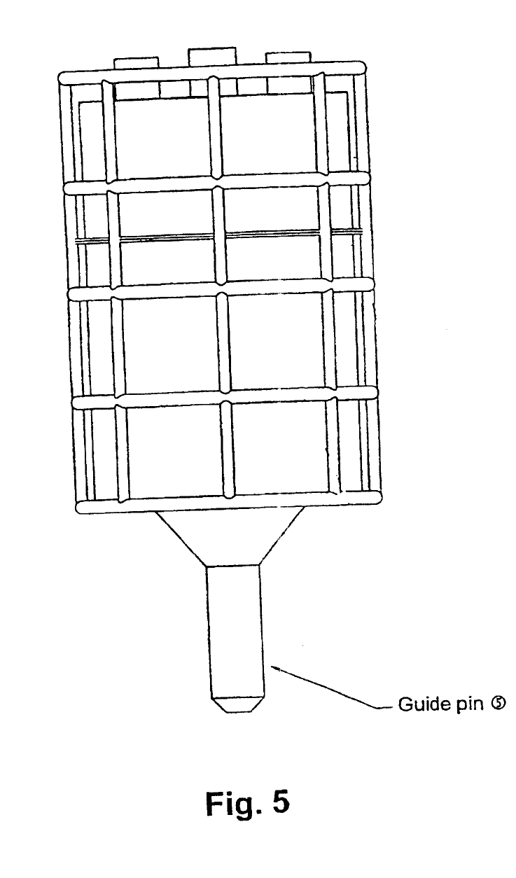

A second embodiment of the present invention is indicated in FIG. 5. This is an “inverted version” of the first embodiment described above. Here, the guide pin (5) and the receiving channel are switched, i.e. the guide pin (5) is axially mounted on the bottom side of the encapsulation, and the receiving channel is mounted in the seafloor foundation (not shown). However, the core elements (3) of the transformer still have to be symmetrically mounted around a central axis running parallel to the core elements, as in the case of the first embodiment. The funnel-shaped opening is now terminating the receiving channel on the top entrance. The method for installing the transformer in the second embodiment differs from the method of the first embodiment in that now, it is the guide pin (5) that is lead to and lowered down into the receiving channel.

In a third embodiment of the invention, the transformer body works as the guide pin itself. As in the second embodiment, the receiving channel is mounted in the seafloor foundation, but it is now adapted to receive and encapsulate the whole transformer body. The method for installing the transformer in the third embodiment differs from the method of the second embodiment in that now, the whole body is being lowered down into the receiving channel.

The above mentioned embodiments for installing a subsea transformer on a foundation at the sea floor have several advantages. Firstly, the present invention allows the transformer to be formed cylindrically, oval or multi-edged. Generally, it is much easier to handle and place objects formed in such a way under water, as opposed to rectangular objects, such as conventional subsea transformers. Rounded encapsulations are e.g. not as vulnerable to underwater currents as rectangular ones, and this is especially important in deeps where guide wires are not used.

Further, in the present invention only one opening has to find its way to one single guide pin during the installation process, and it is obvious that this is considerably easier than when several guide pins and funnels are involved.

Moreover, the present invention eliminates the possibility for the transformer to be wedged between guide pins, since only one single pin is being used. Thus, the risk of loss of or damage to the components will decrease.

Finally, because of the symmetrical forming, the fact that only one single guide pin is being used, and because of the orientation keys, the present invention ensures that the horizontal orientation will be taken care of in a more convenient way.

Note that the foregoing embodiments of the present invention are discussed for illustrative purposes, and are not meant to limit the invention in any way. Nevertheless, different changes and supplements may be added without departing the scope of the invention defined in the following claims.

1. Arrangement for installing a subsea transformer, said arrangement including an engagement means for engaging with a corresponding guide means mounted in a seafloor foundation,
characterized in that said engagement means comprising one single receiving channel (1), said guide means comprising one single guide pin (4), said transformer including a number of core elements (3) symmetrically enclosing said receiving channel (1) so that said receiving channel (1) forms a central axis parallel to said core elements, said receiving channel (1) being adapted for receiving said guide pin (4).

2. Arrangement as defined in claim 1,
characterized in that said core elements (3) are delta-formed.

3. Arrangement as defined in any of the preceding claims,
characterized in that said subsea transformer is encapsulated by a cylindrically or multi-edged capsule.

4. Arrangement as defined in any of the preceding claims, characterized in that said receiving channel (1) is terminated by a funnel-shaped opening (2) at the entrance end.

5. Arrangement as defined in any of the preceding claims, characterized in that said guide pin (4) includes orientation keys for adjusting said receiving channel (1) to a desired, predetermined, horizontal orientation relative to said guide pin (4).

6. Method for installing a subsea transformer, said method involving an engagement means for engaging with a corresponding guide means mounted in a seafloor foundation, characterized in that said engagement means comprising one single receiving channel (1), said guide means comprising one single guide pin (4), said transformer including a number of core elements (3) symmetrically enclosing said receiving channel (1) so that said receiving channel (1) forms a central axis parallel to said core elements, said receiving channel (1) being adapted for receiving said guide pin (4), said receiving channel (1) being lowered onto said guide pin (4).

7. Arrangement for installing a subsea transformer, said arrangement including a guide means for engaging with a corresponding engagement means mounted in a seafloor foundation,
characterized in that said engagement means comprising one single receiving channel, said guide means comprising one single guide pin, said transformer including a number of core elements symmetrically enclosing a central axis running parallel to said core elements, and said receiving channel being adapted for receiving said guide pin.

8. Arrangement as defined in claim 7,
characterized in that said subsea transformer is encapsulated by a cylindrically, oval or multi-edged capsule.

9. Arrangement as defined in claim 7 or 8,
characterized in that said guide pin (5) being axially mounted on the bottom side of said transformer.

10. Arrangement as defined in claim 7 or 8,
characterized in that said guide pin is the transformer body itself.

11. Arrangement as defined in any of the preceding claims depended on claim 7,
characterized in that said core elements are delta-formed.

12. Arrangement as defined in any of the preceding claims depended on claim 7,
characterized in that said receiving channel is terminated by a funnel-shaped opening at the entrance top.

13. Arrangement as defined in any of the preceding claims depended on claim 7,
characterized in that said guide pin includes orientation keys for adjusting said guide pin to a desired, predetermined, horizontal orientation relative to said receiving channel.

14. Method for installing a subsea transformer, said method involving a guide means for engaging with a corresponding engagement means mounted in a seafloor foundation, characterized in that said engagement means comprising one single receiving channel, said guide means comprising one single guide pin, said transformer including a number of core elements symmetrically enclosing a central axis running parallel to said core elements, said receiving channel being adapted for receiving said guide pin, said guide pin being lowered into said receiving channel.
